(19) United States
(12) Patent Application Publication
(10) Pub. No.: US 2007/0014402 A1
(43) Pub. Date: Jan. 18, 2007

(54) Method to detect PAL colorstripe utilizing PAL switch with minimal logic

(76) Inventors: Wen Huang, San Jose, CA (US); Brad Delanghe, Sunnyvale, CA (US); Aleksandr Movshovich, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 11/179,380

(22) Filed: Jul. 12, 2005

(51) Int. Cl. H04N 7/167

(52) U.S. Cl. 380/201

(57) ABSTRACT

A method to detect PAL colorstripe utilizing PAL-switch with minimal logic is provided. A first polarity parameter may be generated by adding an averaged U component value of a current PAL line with a first threshold value. The first polarity parameter may be utilized to detect 180-degree inversion or U axis inversion colorstripe protection. A V component of a current PAL line may be averaged and an inverse of the average generated. A PAL-switch signal may be utilized to select between the average V component value and its inverse value. A second polarity parameter may be generated by adding the selected value with a second threshold value. The second polarity parameter may be utilized to detect V axis inversion colorstripe protection. When colorstripe protection is detected, whether based on the first polarity parameter or the second polarity parameter, a colorstripe detection signal may be generated.

### CROSS-REFERENCE TO RELATED APPLICATIONS/INCORPORATION BY REFERENCE

Not applicable.

### FEDERALLY SPONSORED RESEARCH OR DEVELOPMENT

Not applicable.

### MICROFICHE/COPYRIGHT REFERENCE

Not applicable.

### FIELD OF THE INVENTION

Certain embodiments of the invention relate to video signal detection. More specifically, certain embodiments of the invention relate to a method to detect PAL colorstripe utilizing a PAL switch with minimal logic.

### BACKGROUND OF THE INVENTION

Novel copy-protection mechanisms are becoming necessary in video and/or audio applications in order to discourage the unauthorized or casual copying of recordings without affecting the quality of authorized or legitimate recordings. For this purpose, several digital technologies have been developed, for example, content scrambling system (CSS), content protection for prerecorded media (CPPM), and content protection for recordable media (CPRM). In CSS, copy protection may be achieved by encrypting pre-recorded video content in digital video or versatile disk (DVD) formats. Protection utilizing CPPM may employ encryption of pre-recorded DVD audio content. For CPRM protection, the ability of writeable DVD drives from copying protected content may be limited. While these digital protection technologies are effective in protecting digital content, they are not designed to protect analog signal outputs. For example, these digital security mechanisms may be circumvented by connecting the analog output of a DVD player to a videocassette recorder (VCR), to a personal computer (PC) graphics or sound card, and/or a writeable DVD player. In this regard, DVD players and other recording devices, for example, may be required to provide an analog protection system (APS) to prevent unauthorized copying.

A widely utilized APS is the Macrovision Copy Protection system. The system may employ two techniques, pseudo-sync pulses (PSP) and colorstripe, which utilize the different operations performed by video recorders and video players to achieve protection. These techniques may be as simple as setting a pair of bits instructing a digital-to-analog (D/A) converter in the authoring process to modify the analog output in order to prevent it from being recorded. When implementing the PSP technique, the system may add pulses to the video signal during the vertical blanking intervals in order to affect the automatic gain control (AGC) circuitry in video recorders. This approach may result in unstable recordings that show noise, dimness, color loss, and/or tearing, for example. However, the use of PSP may not be effective in some television sets where the AGC circuit operates slowly and may not be affected by the added pulses.

When implementing the colorstripe technique, the system may introduce phase changes by modulating the colorburst signal in order to affect the chroma processing circuitry in a national televison system committee (NTSC) or phase alternating line (PAL) video recorder, for example. Colorstripe protected recordings may be perceived by a viewer as normal when played on a TV monitor. However, marred horizontal stripes and/or other artifacts may appear when an unauthorized copy is attempted on a colorstripe protected recording. Since several phase changing techniques may be utilized to modify the colorburst signal, a video player may need to identify or detect the type of phase change technique utilized in order for the colorstripe protection to operate effectively. A simple and effective colorstripe detection system may result in a cost effective solution that may be widely implemented for video copying protection.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method to detect PAL colorstripe utilizing a PAL switch with minimal logic, substantially as shown in and/or described in connection with at least one of the drawings, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating exemplary generation of active contents on a video signal, in connection with an embodiment of the invention.

FIG. 1B is a diagram illustrating the position of colorburst and active video in a video signal, in accordance with an embodiment of the invention.

FIG. 2 is a diagram illustrating phase regions for implementing colorstripe copy protection in a PAL video line, in accordance with an embodiment of the invention.

FIG. 3A-3B illustrate exemplary polarities of U and V components for a current non-colorstripe protected PAL line and for a next non-colorstripe protected PAL line respectively, in accordance with an embodiment of the invention.

FIG. 4A-4B illustrate exemplary polarities of U and V components for a current 180° inversion colorstripe protected PAL line and for a next 180° inversion colorstripe protected PAL line respectively, in accordance with an embodiment of the invention.

FIG. 5A-5B illustrate exemplary polarities of U and V components for a current U-axis inversion colorstripe protected PAL line and for a next U-axis inversion colorstripe protected PAL line respectively, in accordance with an embodiment of the invention.

FIG. 6A-6B illustrate exemplary polarities of U and V components for a current V-axis inversion colorstripe protected PAL line and for a next V-axis inversion colorstripe protected PAL line respectively, in accordance with an embodiment of the invention.

FIG. 7A is a diagram illustrating an exemplary PAL colorstripe format, in accordance with an embodiment of the invention.

FIG. 7B is a diagram illustrating an exemplary PAL colorstripe format with PAL-switch signal, in accordance with an embodiment of the invention.

FIG. 8 is a block diagram illustrating an exemplary implementation for colorstripe detection with a PAL-switch signal, in accordance with an embodiment of the invention.

FIG. 9 is a flow diagram illustrating exemplary steps for colorstripe detection with a PAL-switch signal, in accordance with an embodiment of the invention.

### DETAILED DESCRIPTION OF THE INVENTION

Certain embodiments of the invention may be found in a method to detect PAL colorstripe utilizing a PAL-switch with minimal logic. A first polarity parameter may be generated by adding an averaged U component value of a current PAL line with a first threshold value. The first polarity parameter may be utilized to detect 180-degree inversion or U axis inversion colorstripe protection. A V component of a current PAL line may be averaged and an inverse of the average generated. A PAL-switch signal may be utilized to select between the average V component value and its inverse value. A second polarity parameter may be generated by adding the selected value with a second threshold value. The second polarity parameter may be utilized to detect V axis inversion colorstripe protection. When colorstripe protection is detected, whether based on the first polarity parameter or the second polarity parameter, a colorstripe detection signal may be generated.

A picture may be displayed on a television or computer screen by scanning an electrical signal horizontally across the screen one line at a time. The amplitude of the signal at any one point on the line represents the brightness level at that point on the screen. A video frame, for example, may contain the necessary information from the lines that make up the picture and from the associated synchronization (sync) signals to allow a scanning circuit to trace the lines from left to right and from top to bottom in order to recreate the picture on the display. This information includes the luma (Y), or brightness, and the chroma (C), or color, components of the picture. There may be two different types of picture scanning in a video system. The scanning may be interlaced or it may be non-interlaced or progressive. Interlaced scanning occurs when each frame is divided into two separate sub-pictures or fields. The interlaced picture may be produced by first scanning the horizontal lines that correspond to the first field and then retracing to the top of the screen and scanning the horizontal lines that correspond to the second field. The progressive or non-interlaced picture may be produced by scanning all of the horizontal lines of a frame in one pass from the top to the bottom of the screen.

The luma and chroma signal components that represent a picture may be modulated together in order to generate a composite video signal. Integrating the luma and chroma video elements into a composite video stream facilitates video signal processing since only a single composite video stream is transmitted, for example. Once a composite signal is received, the luma and chroma signal components are separated in order for the video signal to be processed and displayed as a picture on the display. For example, a television may be adapted to receive a composite video input but the chroma and luma video components have to be separated before the television can display the received video signal. The luma and chroma separation from a composite video signal may be followed by a quadrature demodulation operation to generate video baseband components, for example, I and Q components for NTSC systems and U and V components for PAL systems, from the chroma information. In PAL systems, for example, the phase of the V component may be inverted every other line of video.

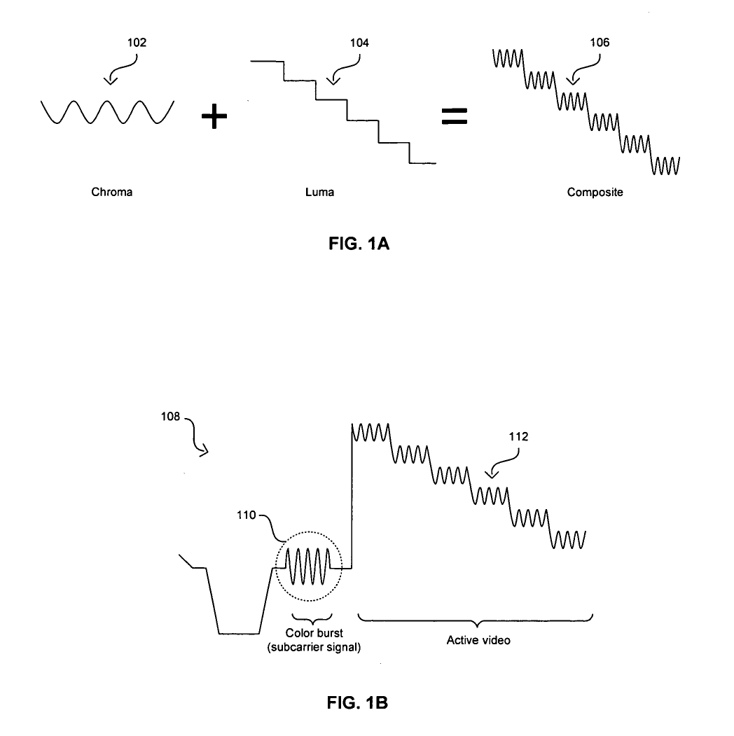

FIG. 1A is a diagram illustrating exemplary generation of active contents on a video signal, in connection with an embodiment of the invention. Referring to FIG. 1A, there is shown a chroma signal component 102, a luma signal component 104, and a video signal 106. In this regard, adding the chroma signal component 102 and the luma signal component 104 may produce the video signal 106. The chroma signal component 102 may correspond to the color information of a line in a video field or frame. The luma signal information 104 may correspond to the brightness information of a line in a video field or frame. The video signal 106 may be referred to as a composite video signal, for example, because chroma and luma information for a line in a video field or frame are combined into a single signal. The luma signal component 104 may or may not increase in amplitude in a stair step fashion. The chroma signal component 102 may comprise a color difference component U that is modulated by, for example, a sine signal with a 3.58 MHz frequency, and a color difference component V that is modulated by, for example, a cosine signal with a 3.58 MHz frequency. The modulation scheme may be selected so that it provides quadrature modulation between the U and V color difference components. An exemplary video signal 106 may be a composite video signal with burst and syncs (CVBS).

FIG. 1B is a diagram illustrating the position of colorburst and active video in a video signal, in accordance with an embodiment of the invention. Referring to FIG. 1B, there is shown a video signal 108 where a portion of the video signal 108 may be a colorburst 110 and a different portion may be the active video signal 112. The colorburst 110 may comprise a brief sample of, for example, eight to ten cycles of an unmodulated color subcarrier which have been inserted by an NTSC or PAL encoder onto the back porch of the composite video signal to enable a decoder to regenerate the color subcarrier from it. The active video portion 112 of the video signal 108 contains the luma and chroma signal components of the picture or image. In this regard, the video signal 108 may be referred to as a composite video signal.

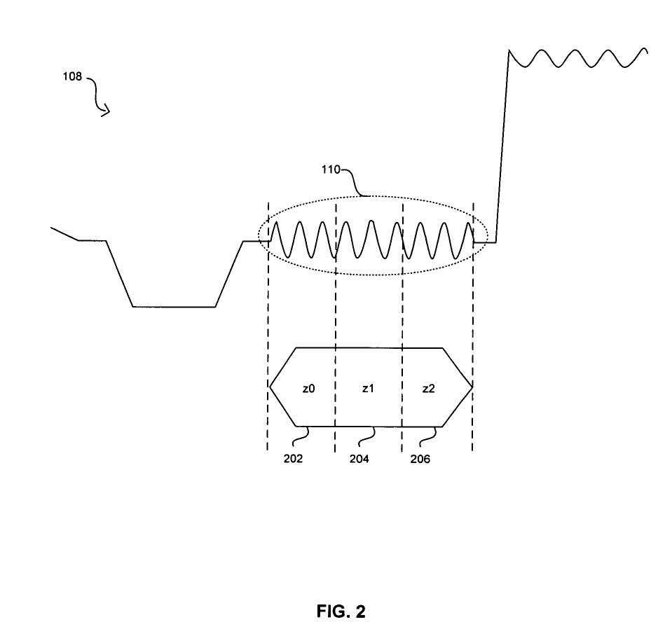

FIG. 2 is a diagram illustrating phase regions for implementing colorstripe copy protection in a PAL video line, in accordance with an embodiment of the invention. Referring to FIG. 2, there is shown the video signal 108 in FIG. 1B with a first phase zone 202, a second phase zone 204, and a third phase zone 206 that may be utilized to modify the phase of the color subcarrier in the colorburst 110. Each of the first phase zone 202, the second phase zone 204, and the third phase zone 206 may correspond to a region of the colorburst 110 where a colorstripe copy protection technique may be implemented. For example, the first phase zone 202 may correspond to a portion of the colorburst 110 that may be modified by a first phase φ₁, the second phase zone 204 may correspond to a next portion of the colorburst 110 that may be modified or modulated by a second phase φ₂, and the third phase zone 206 may correspond to remaining portion of the colorburst 110 that may be modified by a third phase φ₃. While FIG. 2 shows the colorburst 110 partitioned into three zones or regions for implementing colorstripe copy protection, the number of zones into which the colorburst 110 may be partitioned need not be limited.

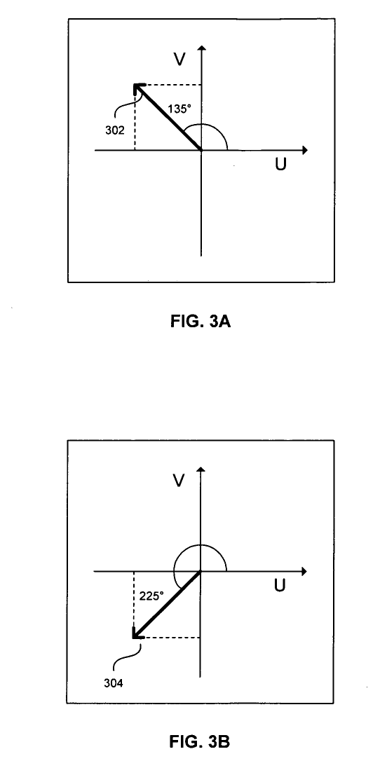

FIG. 3A-3B illustrate exemplary polarities of U and V components for a current non-colorstripe protected PAL line and for a next non-colorstripe protected PAL line respectively, in accordance with an embodiment of the invention. Referring to FIG. 3A, there is shown a chroma signal 302 that corresponds to a current PAL video line when no colorstripe copy protection has been implemented. In this regard, the chroma signal 302 in the current PAL video line comprises a negative polarity (−) U component and a positive polarity (+) V component. Because the polarity of the V component of every other PAL video line may be inverted, the chroma signal 302 may correspond to, for example, an odd PAL video line in a video frame.

Referring to FIG. 3B, there is shown a chroma signal 304 that corresponds to a next PAL video line when no colorstripe copy protection has been implemented. In this regard, the chroma signal 304 in the next PAL video line comprises a negative polarity (−) U component and a negative polarity (−) V component. The chroma signal 304 may correspond to, for example, an even PAL video line in a video frame. In this regard, the chroma signal 302 in FIG. 3A and the chroma signal 304 in FIG. 3B may indicate the relative polarities of U and V components for consecutive PAL video lines in a video frame, for example.

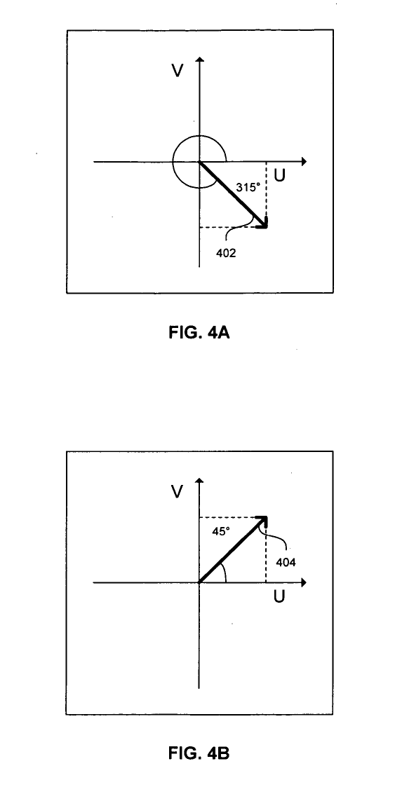

FIG. 4A-4B illustrate exemplary polarities of U and V components for a current 180° inversion colorstripe protected PAL line and for a next 180° inversion colorstripe protected PAL line respectively, in accordance with an embodiment of the invention. Referring to FIG. 4A, there is shown a chroma signal 402 that corresponds to a current PAL video line when a 180° inversion colorstripe copy protection technique has been implemented. In this regard, there is a 180° phase difference between the chroma signal 402 and the chroma signal 302 with no colorstripe copy protection in FIG. 3A. The chroma signal 402 comprises a positive polarity (+) U component and a negative polarity (−) V component and may correspond to an odd PAL video line in a video frame, for example.

Referring to FIG. 4B, there is shown a chroma signal 404 that corresponds to a next PAL video line when a 180° inversion colorstripe copy protection technique has been implemented. In this regard, there is a 180° phase difference between the chroma signal 404 and the chroma signal 304 with no colorstripe copy protection in FIG. 3B. The chroma signal 404 comprises a positive polarity (+) U component and a positive polarity (+) V component and may correspond to an even PAL video line in a video frame, for example.

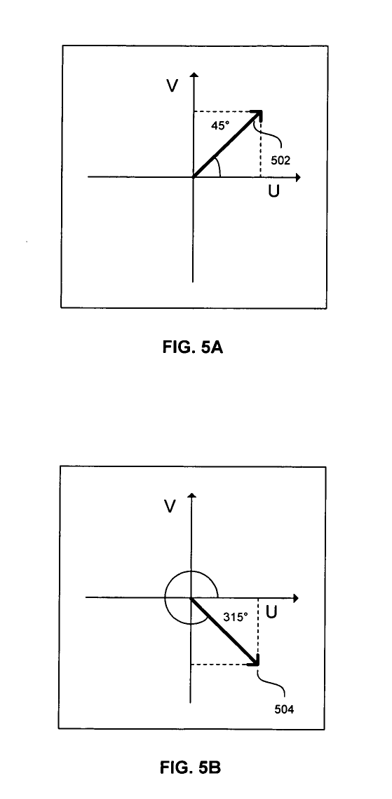

FIG. 5A-5B illustrate exemplary polarities of U and V components for a current U-axis inversion colorstripe protected PAL line and for a next U-axis inversion colorstripe protected PAL line respectively, in accordance with an embodiment of the invention. Referring to FIG. 5A, there is shown a chroma signal 502 that corresponds to a current PAL video line when an U-axis inversion colorstripe copy protection technique has been implemented. In this regard, there is an inversion of the polarity of the U component between the chroma signal 502 and the chroma signal 302 with no colorstripe copy protection in FIG. 3A. The chroma signal 502 comprises a positive polarity (+) U component and a positive polarity (+) V component and may correspond to an odd PAL video line in a video frame, for example.

Referring to FIG. 5B, there is shown a chroma signal 504 that corresponds to a next PAL video line when a U-axis inversion colorstripe copy protection technique has been implemented. In this regard, there is an inversion of the polarity of the U component between the chroma signal 504 and the chroma signal 304 with no colorstripe copy protection in FIG. 3B. The chroma signal 504 comprises a positive polarity (+) U component and a negative polarity (−) V component and may correspond to an even PAL video line in a video frame, for example.

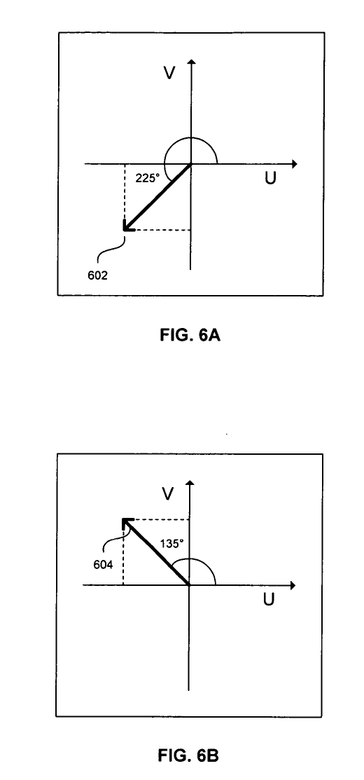

FIG. 6A-6B illustrate exemplary polarities of U and V components for a current V-axis inversion colorstripe protected PAL line and for a next V-axis inversion colorstripe protected PAL line respectively, in accordance with an embodiment of the invention. Referring to FIG. 6A, there is shown a chroma signal 602 that corresponds to a current PAL video line when a V-axis inversion colorstripe copy protection technique has been implemented. In this regard, there is an inversion of the polarity of the V component between the chroma signal 602 and the chroma signal 302 with no colorstripe copy protection in FIG. 3A. The chroma signal 602 comprises a negative polarity (−) U component and a negative polarity (−) V component and may correspond to an odd PAL video line in a video frame, for example.

Referring to FIG. 6B, there is shown a chroma signal 604 that corresponds to a next PAL video line when a V-axis inversion colorstripe copy protection technique has been implemented. In this regard, there is an inversion of the polarity of the V component between the chroma signal 604 and the chroma signal 604 with no colorstripe copy protection in FIG. 3B. The chroma signal 604 comprises a negative polarity (−) U component and a positive polarity (+) V component and may correspond to an even PAL video line in a video frame, for example.

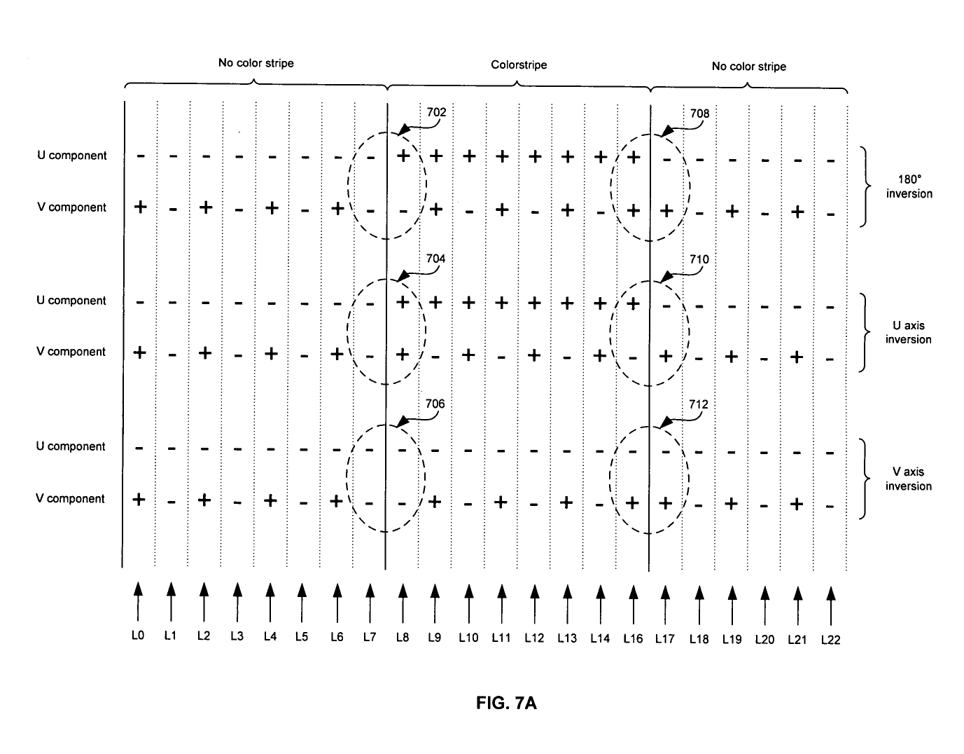

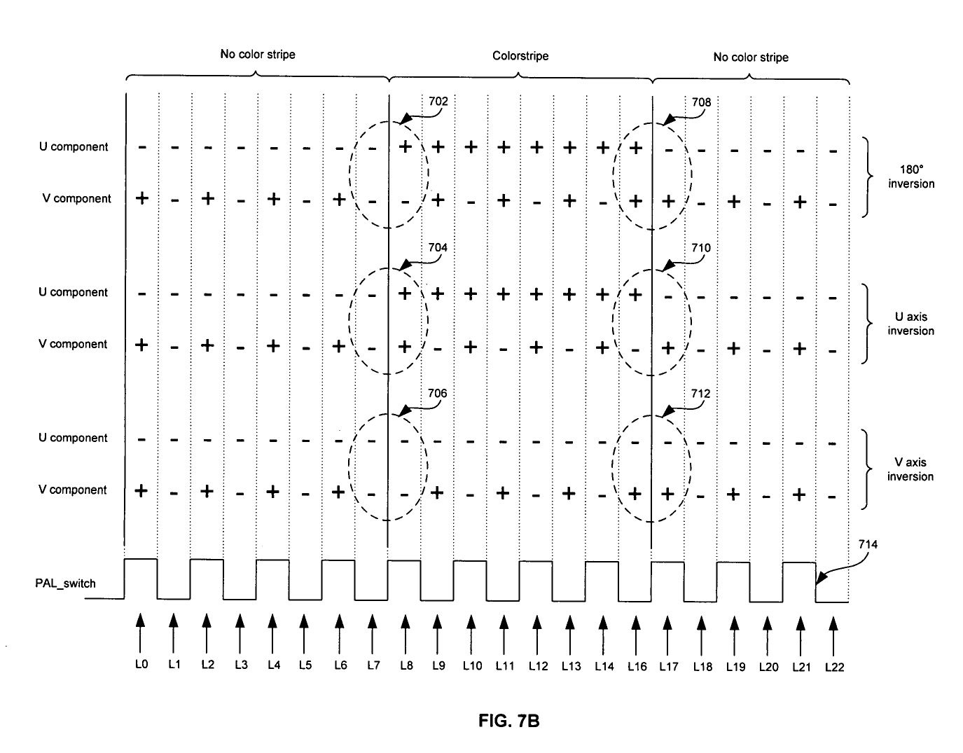

FIG. 7A is a diagram illustrating an exemplary PAL colorstripe format, in accordance with an embodiment of the invention. Referring to FIG. 7A, there is shown a plurality of PAL video lines labeled L0 to L22, where L0 may correspond to a first or reference PAL video line in a video frame and L1 to L22 may correspond to subsequent PAL video lines in the video frame. As shown in FIG. 7A, it may be sufficient to implement colorstripe copy protection in a portion of the video lines in a video frame. For example, lines L0 to L7 and L17 to L22 are not protected by colorstripe while lines L8 to L16 are protected by colorstripe.

The U component may have a negative polarity (−) while the V component may alternate between a positive polarity (+) and a negative polarity (−) in those portions of the video frame where colorstripe copy protection is not supported. When the 180° inversion colorstripe copy protection technique is implemented, a change in the polarities of the U and V components may occur as shown by an interface region 702 between lines L7 and L8. As a result of implementing the 180° inversion colorstripe technique, the U component in line L8 has a positive polarity (+) while the V component in line L8 has a negative polarity (−). The positive polarity (+) of the U component in line L8 is inverted from the negative polarity (−) in line L7. The negative polarity (−) of the V component in line L8 is inverted from the positive polarity (+) that should follow the negative polarity (−) in line L7.

When the 180° inversion colorstripe copy protection technique is removed, a change in the polarities of the U and V components may occur as shown by an interface region 708 between lines L16 and L17. As a result of removing the 180° inversion colorstripe technique, the U component in line L17 has a negative polarity (−) while the V component in line L17 has a positive polarity (+). The negative polarity (−) of the U component in line L17 is inverted from the positive polarity (+) in line L16. The positive polarity (+) of the V component in line L17 is inverted from the negative polarity (−) that should follow the positive polarity (+) in line L16.

When the U-axis inversion colorstripe copy protection technique is implemented, a change in the polarity of the U component may occur as shown by an interface region 704 between lines L7 and L8. As a result of implementing the U-axis inversion colorstripe technique, the U component in line L8 has a positive polarity (+) while the V component in line L8 has a positive polarity (+). The positive polarity (+) of the U component in line L8 is inverted from the negative polarity (−) in line L7. The positive polarity (+) of the V component in line L8 is in accordance with the polarity that should follow the negative polarity (−) in line L7 in a PAL video frame.

When the U-axis inversion colorstripe copy protection technique is removed, a change in the polarity of the U component may occur as shown by an interface region 710 between lines L16 and L17. As a result of removing the U-axis inversion colorstripe technique, the U component in line L17 has a negative polarity (−) while the V component in line L17 has a positive polarity (+). The negative polarity (−) of the U component in line L17 is inverted from the positive polarity (+) in line L16. The positive polarity (+) of the V component in line L17 is in accordance with the polarity that should follow the negative polarity (−) in line L16.

A change in the polarity of the U component from negative polarity (−) to positive polarity (+) may indicate the implementation of either the 180° inversion colorstripe technique or the U-axis inversion colorstripe technique. Similarly, a change in the polarity of the U component from positive polarity (+) to negative polarity (−) may indicate the removal of either the 180° inversion colorstripe technique or the U-axis inversion colorstripe technique.

When the V-axis inversion colorstripe copy protection technique is implemented, a change in the polarity of the V component may occur as shown by an interface region 706 between lines L7 and L8. As a result of implementing the V-axis inversion colorstripe technique, the V component in line L8 has a negative polarity (−) and the V component in line L8 has a negative polarity (−). The negative polarity (−) of the U component in line L8 is in accordance with the polarity for U components in a PAL video frame. The negative polarity (−) of the V component in line L8 is inverted from the positive polarity (+) that should follow the negative polarity (−) in line L7.

When the V-axis inversion colorstripe copy protection technique is removed, a change in the polarity of the V component may occur as shown by an interface region 712 between lines L16 and L17. As a result of removing the V-axis inversion colorstripe technique, the U component in line L17 has a negative polarity (−) while the V component in line L17 has a positive polarity (+). The negative polarity (−) of the U component in line L17 is in accordance with the polarity for U components in a PAL video frame. The positive polarity (+) of the V component in line L17 is inverted from the negative polarity (−) that should follow the positive polarity (+) in line L16.

FIG. 7B is a diagram illustrating an exemplary PAL colorstripe format with PAL-switch signal, in accordance with an embodiment of the invention. Referring to FIG. 7B, there is shown a PAL-switch signal 714 that may indicate the polarity of the V component of a PAL video line when no colorstripe copy protection is supported. In this regard, the rising edge of the PAL-switch signal 714 may indicate the start of a PAL video line with positive polarity V component. For example, the signal value of the PAL-switch signal 714 may be high for PAL video lines with positive polarity (+) V component and may be low for PAL video lines with negative polarity (−) V component. In this regard, when a colorstripe copy protection technique modifies the phase or polarity of the V component of a current PAL video line, the value of the PAL-switch signal 714 may indicate the polarity of the current PAL video line without colorstripe copy protection.

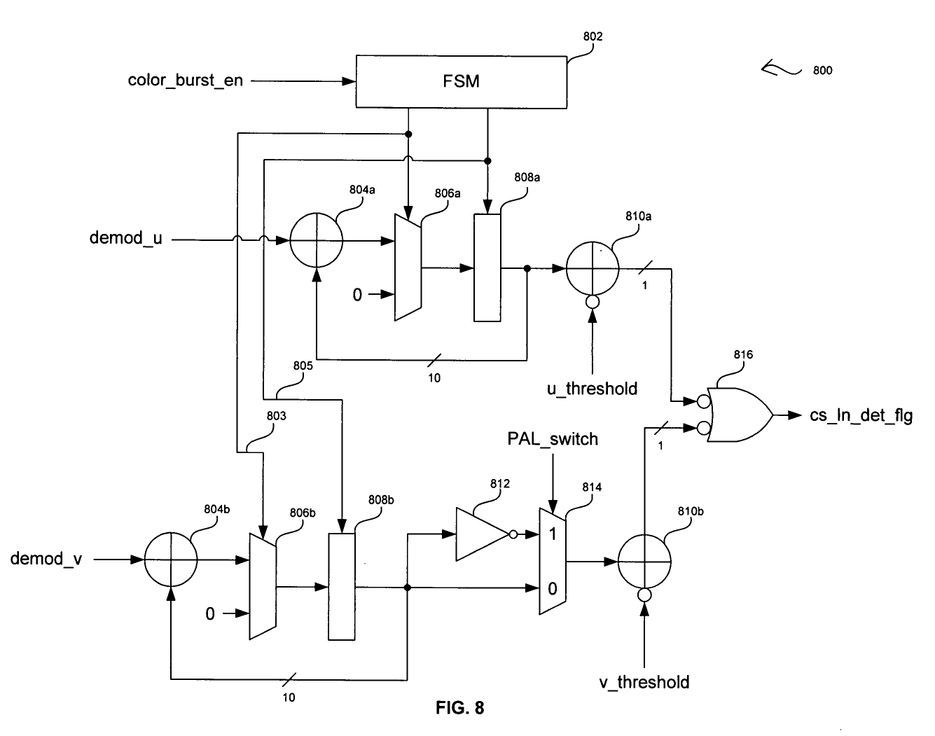

FIG. 8 is a block diagram illustrating an exemplary implementation for colorstripe detection with a PAL-switch signal, in accordance with an embodiment of the invention. Referring to FIG. 8, there is shown a colorstripe detector 800 that may comprise a finite state machine (FSM) 802, adders 804a and 804b, multiplexers 806a and 806b, registers 808a and 808b, adders 810a and 810b, an inverter 812, a switch 814, and a XOR gate 816. The FSM 802 may comprise suitable logic, circuitry, and/or code that may be adapted to generate control signals from an enable signal, such as a color_burst_en signal. The FSM 802 may be adapted to generate a first control signal 803 that may be utilized to control the operation of the multiplexers 806a and 806b. The FSM 802 may also be adapted to generate a second control signal 805 that may be utilized to control the operation of the registers 808a and 808b.

The adder 804a may comprise suitable logic, circuitry, and/or code that may be adapted to add a U component signal, such as a demod_u signal, to the output of the register 808a. In this regard, the signals may be 10-bit signals, for example. The output of the adder 804a may be transferred to an input of the multiplexer 806a. Similarly, the adder 804b may comprise suitable logic, circuitry, and/or code that may be adapted to add a V component signal, such as a demod_v signal, to the output of the register 808b. In this regard, the signals may be 10-bit signals, for example. The output of the adder 804b may be transferred to an input of the multiplexer 806b. The multiplexers 806a and 806b may comprise suitable logic, circuitry, and/or code that may be adapted to select between the output of the adders 804a and 804b respectively and a reference value, such as logic 0, for example. In this regard, the multiplexers 806a and 806b may utilize the first control signal 803 to select an input signal.

The registers 808a and 808b may comprise suitable logic, circuitry, and/or code that may be adapted to store the values generated by the multiplexers 806a and 806b respectively, for example. In this regard, the registers 808a and 808b may utilize the second control signal 805 to control the storage operation. Moreover, the output of the registers 808a and 808b may be 10-bits wide, for example. The output of the register 808a may be transferred to the adder 804a while the output of the register 808b may be transferred to the adder 804b and/or to the input of the inverter 812. The inverter 812 may comprise suitable logic, circuitry, and/or code that may be adapted to invert the output of the register 808b.

The switch 814 may comprise suitable logic, circuitry, and/or code that may be adapted to select between the output of the inverter 812 and the output of the register 808b. In this regard, the switch 814 may utilize the PAL-switch signal value to select an input signal. For example, when the PAL-switch signal value is high or logic 1, the switch 814 may select the output of the inverter 812. When the PAL-switch signal value is low or logic 0, the switch 814 may select the output of the register 808b, for example.

The adder 810a may comprise suitable logic, circuitry, and/or code that may be adapted to add the output of the register 808a and a threshold signal, such as a u_threshold signal. The threshold signal may be utilized to remove, for example, a noise floor in the average value of the demod_u signal. In this regard, programmable registers may be utilized to store the value of the u_threshold signal and may be dynamically updated as the noise floor varies. The threshold signal may be inverted before being added to the output of the register 808a. The output of the adder 810a may be transferred to the XOR gate 816. The adder 810b may comprise suitable logic, circuitry, and/or code that may be adapted to add the output of the switch 814 and a threshold signal, such as a v_threshold signal. The threshold signal may be utilized to remove, for example, a noise floor in the average value of the demod_v signal. In this regard, programmable registers may be utilized to store the value of the v_threshold signal and may be dynamically updated as the noise floor varies. The threshold signal may be inverted before being added to the output of the switch 814.

The output of the adder 810b may be transferred to the XOR gate 816. The outputs of the adders 810a and 810b may be, for example, 1-bit wide and may correspond, respectively, to a first polarity parameter and to a second polarity parameter. The first polarity parameter may represent information regarding the polarity of the U component in a PAL video line while the second polarity parameter may represent information regarding the polarity of the V component in a PAL video line. The XOR gate 816 may comprise suitable logic, circuitry, and/or code that may be adapted to XOR the first polarity component and the second polarity component to generate a colorstripe copy protection detection signal, cs_ln_det_flag. In this regard, the XOR gate 816 may have inverted inputs and the first polarity parameter and the second polarity parameter may be inverted before the XOR operation.

In operation, the FSM 802 may generate the control signals 803 and 805 to indicate the initial settings for the multiplexers 806a and 806b and for the registers 808a and 808b. In this regard, the multiplexers 806a and 806b may select the logic 0 input and the registers 808a and 808b may be reset to logic 0 outputs, for example. The adder 804a may receive the demod_u signal and may add logic 0. The FSM 802 may update the first control signal 803 to select the output of the adder 804a in the multiplexer 806a. The register 808a may generate an output that corresponds to the average value of the demod_u signal and may feed back the average value of the demod_u signal to the adder 804a. The output of the register 808a may be transferred to the adder 810a, where the u_threshold signal may be used as a reference value to generate the first polarity parameter.

Similarly, the adder 804b may receive the demod_v signal and may add a logic 0. The FSM 802 may update the first control signal 803 to select the output of the adder 804b in the multiplexer 806b. The register 808b may generate an output that corresponds to the average value of the demod_v signal and may feed back the average value of the demod_v signal to the adder 804b. The output of the register 808b may be transferred to the inverter 812 and to the switch 814 where the signal value of the PAL-switch signal may select between the two input values. The output of the switch 814 may be transferred to the adder 810b, where the v_threshold signal may be used as a reference value to generate the second polarity parameter. The first polarity parameter and the second polarity parameter may be transferred to the XOR gate. When either the first polarity parameter or the second polarity parameter are deasserted, the output of the XOR gate 816, the cs_In_det_flag signal, may be asserted to indicate that colorstripe copy protection has been detected for the current PAL video line.

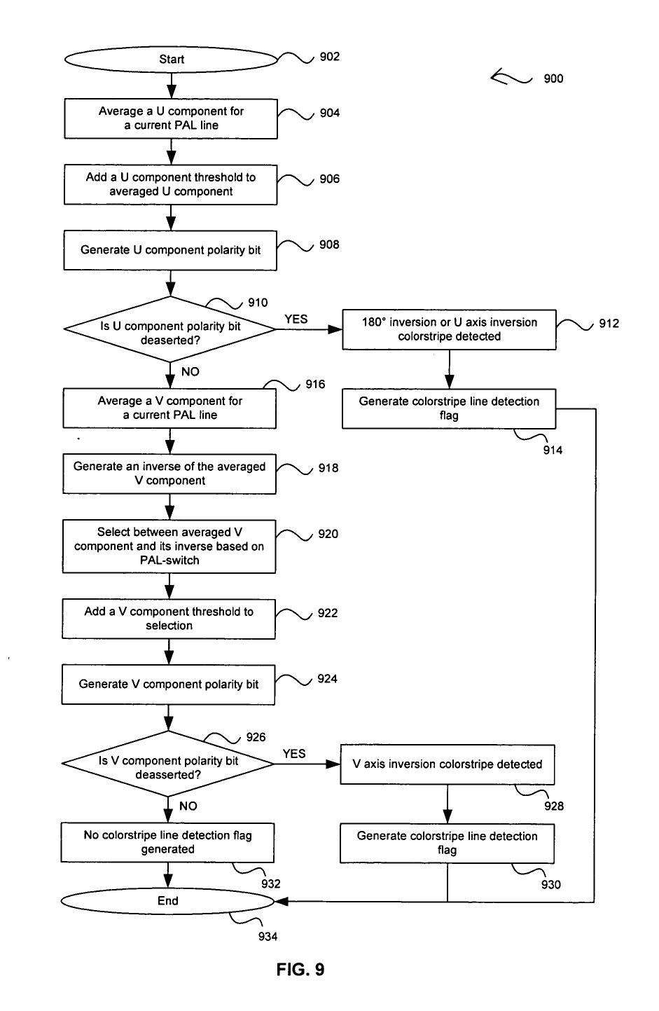

FIG. 9 is a flow diagram illustrating exemplary steps for colorstripe detection with a PAL-switch signal, in accordance with an embodiment of the invention. Referring to FIG. 9, after start step 902, in step 904, the U component for a current PAL video line may be averaged by utilizing the colorstripe detector 800 in FIG. 8, for example. In step 906, a threshold value may be added to the average value of the U component to generate a polarity parameter that indicates whether the polarity of the U component has changed. In step 908, the U component polarity parameter or polarity bit may be generated. In step 910, the detector 800 may determine whether the U component polarity parameter or polarity bit is deasserted. When the polarity bit is deasserted, the U component has a positive polarity and the process may proceed to step 912. In step 912, a positive polarity U component corresponds to a 180° inversion or a U-axis inversion colorstripe copy protection technique being detected. In step 914, the XOR gate 816 generates a colorstripe detection flag when the U component polarity parameter or polarity bit is deasserted to indicate that 180° inversion or U-axis inversion colorstripe copy protection technique has been detected. After step 914, the process may proceed to end step 934.

Returning to step 910, when the U component polarity bit is asserted, the U component has a negative polarity and the process may proceed to step 916. In step 916, the V component for a current PAL video line may be averaged by utilizing the colorstripe detector 800 in FIG. 8, for example. In step 918, an inverse of the average value of the V component may be generated. In step 920, the PAL-switch signal value may be utilized to select between the average V component value or the inverse of the average V component value. In this regard, when the PAL-switch signal value is asserted, which corresponds to a V component with a positive polarity when no colorstripe is present, the switch 814 may select the inverse of the average V component value. When the PAL-switch signal value is deasserted, which corresponds to a V component with a negative polarity when no colorstripe protection is present, the switch 814 may select the average V component value. In step 922, a threshold value may be added to the selected value from the switch 814 to generate a polarity parameter that indicates whether the polarity of the V component corresponds to the polarity indicated by the PAL-switch signal. In step 924, the V component polarity parameter or polarity bit may be generated.

In step 926, the detector 800 may determine whether the V component polarity parameter or polarity bit is deasserted. When the polarity bit is deasserted, the V component has a polarity that is inverted when compared to the polarity of the PAL-switch signal and the process may proceed to step 928. In step 928, an inverted polarity V component corresponds to a V-axis inversion colorstripe copy protection technique being detected. In step 930, the XOR gate 816 generates a colorstripe detection flag when the V component polarity parameter or polarity bit is deasserted to indicate that V-axis inversion colorstripe copy protection technique has been detected. After step 930, the process may proceed to end step 934. Returning to step 926, when the V component polarity bit is asserted, the V component has the appropriate polarity and the process may proceed to step 932 where no colorstripe detection flag is generated. After step 932, the process may proceed to end step 934.

The approach described herein provides a simple and effective colorstripe detection system resulting in a cost effective solution that may be widely implemented in video copying protection systems.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for detecting copy protection, the method comprising:
generating a first polarity parameter based on a U component of a current PAL line;
generating a second polarity parameter based on a V component of said current PAL line and a PAL-switch signal value; and
generating a colorstripe detection signal based on said generated first polarity parameter and said generated second polarity parameter.

2. The method according to claim 1, further comprising averaging said U component of said current PAL line.

3. The method according to claim 2, further comprising adding said averaged U component of said current PAL line to a first threshold value.

4. The method according to claim 3, further comprising inverting said first threshold value prior to adding to said averaged U component of said current PAL line.

5. The method according to claim 1, further comprising averaging said V component of said current PAL line.

6. The method according to claim 5, further comprising generating an inverse of said averaged V component of said current PAL line.

7. The method according to claim 6, further comprising selecting between said averaged V component of said current PAL line and said inverse of said averaged V component of said current PAL line by utilizing said PAL-switch signal value.

8. The method according to claim 7, further comprising adding a second threshold value to said selected averaged V component of said current PAL line or said selected inverse of said averaged V component of said current PAL line.

9. The method according to claim 8, further comprising inverting said second threshold value prior to adding to said selected averaged V component of said current PAL line or said selected inverse of said averaged V component of said current PAL line.

10. The method according to claim 1, further comprising generating said colorstripe detection signal by XORing an inverse of said generated first polarity parameter with an inverse of said generated second polarity parameter.

11. A system for detecting copy protection, the system comprising:
circuitry that generates a first polarity parameter based on a U component of a current PAL line;
circuitry that generates a second polarity parameter based on a V component of said current PAL line and a PAL-switch signal value; and
circuitry that generates a colorstripe detection signal based on said generated first polarity parameter and said generated second polarity parameter.

12. The system according to claim 11, further comprising circuitry that averages said U component of said current PAL line.

13. The system according to claim 12, further comprising an adder that adds said averaged U component of said current PAL line to a first threshold value.

14. The system according to claim 13, further comprising an inverter that inverts said first threshold value prior to adding to said averaged U component of said current PAL line.

15. The system according to claim 11, further comprising circuitry that averages said V component of said current PAL line.

16. The system according to claim 15, further comprising an inverter that generates an inverse of said averaged V component of said current PAL line.

17. The system according to claim 16, further comprising a multiplexer that selects between said averaged V component of said current PAL line and said inverse of said averaged V component of said current PAL line by utilizing said PAL-switch signal value.

18. The system according to claim 17, further comprising an adder that adds a second threshold value to said selected averaged V component of said current PAL line or said selected inverse of said averaged V component of said current PAL line.

19. The system according to claim 18, further comprising an inverter that inverts said second threshold value prior to adding to said selected averaged V component of said current PAL line or said selected inverse of said averaged V component of said current PAL line.

20. The system according to claim 11, further comprising an XOR gate that generates said colorstripe detection signal by XORing an inverse of said generated first polarity parameter with an inverse of said generated second polarity parameter.
